(19) United States
(12) Patent Application Publication
(10) Pub. No.: US 2022/0079272 A1
(43) Pub. Date: Mar. 17, 2022

(54) ANTIBACTERIAL DEODORANT QUICK-DRYING MASK

(71) Applicant: HUIZHOU LIXING TEXTILE CO., LTD., HUIZHOU (JP)

(72) Inventor: YUAN LIANG, Shenzhen (CN)

(21) Appl. No.: 17/017,691

(22) Filed: Sep. 11, 2020

(51) Int. Cl. A41D 13/11; A41D 31/10; A41D 31/30

(52) U.S. Cl. CPC A41D 13/1192; A41D 13/1161; A41D 31/10; A41D 2500/30; A41D 2400/36; A41D 2500/20; A41D 2500/10; A41D 31/305

(57) ABSTRACT

The invention discloses an antibacterial deodorant quick-drying mask comprising a mask body and a strap, wherein the mask body comprises a water repellent outer cloth layer, a first upright cotton layer, a first needle-punched cotton layer, a melt-blown cloth layer, a second needle-punched cotton layer, a second upright cotton layer and an inner functional cloth layer. The inner functional cloth layer is woven by antibacterial yarns and spandex yarns, and a quick-drying aid is added into the inner functional cloth layer. The invention has the functions of antibiosis, deodorization and quick-drying, has soft hand feeling, is safe to use and high in comfort level and filtering rate, does not wrinkle, and enables the mask to keep the original contour all the time.

### TECHNICAL FIELD

The invention relates to the technical field of masks, in particular to an antibacterial deodorant quick-drying mask.

### BACKGROUND OF THE PRESENT INVENTION

Most of the large-scale epidemic outbreaks in recent years are respiratory infectious diseases, such as COVID-19, influenza, tuberculosis, influenza A-H1N1, highly pathogenic avian influenza, etc. In addition, with the rapid development of industry, the air pollution is also caused to be intensified day by day, so that the air quality is getting worse and worse and a large number of diseases related to air pollution are caused, such as lung cancer, chronic bronchitis, asthma and other respiratory diseases. The respiratory diseases are transmitted through droplets and the air, having the characteristics of high transmission speed, a wide susceptible population and high incidence rate, and the public health and social stability are greatly threatened. The protective mask can prevent viruses and bacteria from invading the human body and is an effective means for preventing the epidemic of respiratory infectious diseases and protecting the health of people.

However, the existing masks have a single function, which can only block bacteria and dust particles in the air, and basically have no effect on inhibiting or killing viruses and bacteria, and do not have deodorant and quick-drying effects, and thus cannot meet high performance requirements.

### SUMMARY OF THE PRESENT INVENTION

It is an object of the present invention to overcome the above-mentioned disadvantages of the prior art and to provide an antibacterial deodorant quick-drying mask.

To achieve the above object, the present invention provides an antibacterial deodorant quick-drying mask, comprising a mask body and a strap connected to the mask body, wherein the mask body comprises a water repellent outer cloth layer, a first upright cotton layer, a first needle-punched cotton layer, a melt-blown cloth layer, a second needle-punched cotton layer, a second upright cotton layer and an inner functional cloth layer, wherein the water repellent outer cloth layer, the first upright cotton layer, the first needle-punched cotton layer, the melt-blown cloth layer, the second needle-punched cotton layer, the second upright cotton layer and the inner functional cloth layer are sequentially laminated and connected from outside to inside, the inner functional cloth layer is woven by antibacterial yarns and spandex yarns, and a quick-drying aid is added into the inner functional cloth layer.

The antibacterial yarn is a polyester yarn with a zinc ion antibacterial agent.

The quick-drying aid is a moisture-absorbing and perspiration-releasing finishing agent.

A fluorescent brightener is also added in the inner functional cloth layer.

A fragrance is also added into the inner functional cloth layer.

The weaving mode of the antibacterial yarn and the spandex yarn is weft knitting or warp knitting.

The gram weight of the first upright cotton layer, the first needle-punched cotton layer, the second needle-punched cotton layer, and the second upright cotton layer is 80-120 g/m².

The melt-blown cloth layer is provided with two layers.

The filtering rate of the melt-blown cloth layer is as follows: oil PFE≥95%, salt PFE≥95%.

The water repellent outer cloth layer is made of water repellent polyester cloth, nylon cloth or non-woven cloth; and a nose bridge metal strip which is located at an upper end part of the surface of the water repellent outer cloth layer and can be bent is connected to the outside of the mask body.

Compared with the prior art, the invention has the following advantages.

1. According to the invention, the inner functional cloth layer woven by the antibacterial yarns and the spandex yarns is adopted, wherein the antibacterial yarns have long-acting antibacterial sterilization and deodorization functions and are safe to human bodies; and the spandex yarns can utilize chemical bonds to attract odoriferous substances (such as acetic acid, ammonia, isovaleric acid, nonenal and the like) to reduce peculiar smell and further improve the deodorization effect. After the antibacterial yarn and the spandex yarn are mixed and woven, the elasticity is good, such that the inner functional cloth layer has a comfortable and soft hand feeling, and wrinkles are avoided, and the original contour of the mask is kept all the time. A quick-drying aid is added to the inner functional cloth layer to accelerate the rate of moisture absorption and perspiration release and provides a quick-drying effect to the mask.

2. The upright cotton and the needle-punched cotton combined structure of the invention is light in weight and good in air permeability, not only plays a good role in supporting and shaping to keep the mask in 3D structure, but also plays a role in filtering and absorbing moisture.

3. The mask disclosed by the invention is high in comfort level, good in fit with the face, soft in hand feeling and high in filtering rate, and meets the requirements of national and international standards for filtering rate and breathing resistance.

4. According to the mask of the invention, fragrances can be added according to actual needs, and the wearing experience of a user is improved.

### BRIEF DESCRIPTION OF THE DRAWINGS

FIG. 1 is a schematic view showing the structure of an antibacterial deodorant quick-drying mask;

FIG. 2 is a schematic view showing a layer structure of an antibacterial deodorant quick-drying mask.

### DETAILED DESCRIPTION OF THE PRESENT INVENTION

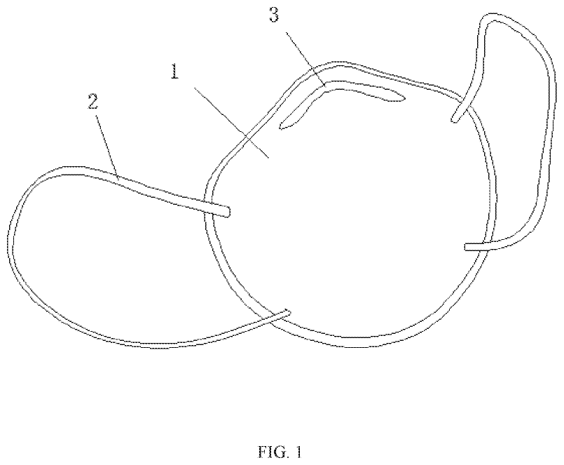

Referring to FIG. 1, an embodiment of the present invention provides an antibacterial, deodorant and quick-drying mask comprising a mask body 1 and a strap 2 and other parts, each of which is described in detail with reference to the accompanying drawings.

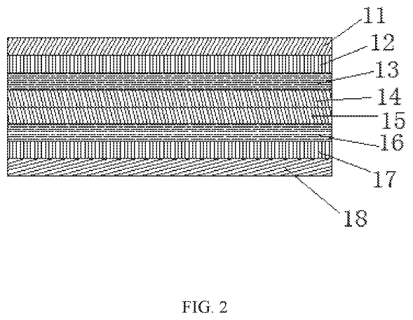

As shown in FIG. 1, the mask body 1 may be provided in a bowl-shaped 3D structure, which has a good fit with the face and is comfortable to wear. As shown in FIG. 2, the mask body 1 may include a water-repellent outer cloth layer 11, a first upright cotton layer 12, a first needle-punched cotton layer 13, a first melt-blown cloth layer 14, a second melt-blown cloth layer 15, a second needle-punched cotton layer 16, a second upright cotton layer 17 and an inner functional cloth layer 18, wherein the water-repellent outer cloth layer 11, the first upright cotton layer 12, the first needle-punched cotton layer 13, the first melt-blown cloth layer 14, the second melt-blown cloth layer 15, the second needle-punched cotton layer 16, the second upright cotton layer 17 and the inner functional cloth layer 18 are sequentially, laminated and connected together from outside to inside, and the edge portions of the water-repellent outer cloth layer 11, the first upright cotton layer 12, the first needle-punched cotton layer 13, the first melt-blown cloth layer 14, the second melt-blown cloth layer 15, the second needle-punched cotton layer 16, the second upright cotton layer 17 and the inner functional cloth layer 18 can be connected in an ultrasonic hot melting manner.

Preferably, the water-repellent outer cloth layer 11 may be provided as a water-repellent polyester cloth, nylon cloth or non-woven cloth, although other types of water-repellent cloth may be used.

The gram weight of the first upright cotton layer 12, the first needle-punched cotton layer 13, the second needle-punched cotton layer 16 and the second upright cotton layer 17 is 80-120 g/m². The upright cotton and the needle-punched cotton combined structure is light in weight and good in air permeability, not only plays a good role in supporting and shaping to keep the mask in 3D structure, but also plays a role in filtering and absorbing moisture.

The filtering rates of the first melt-blown layer 14 and the second melt-blown layer 15 are as follows: oil PFE≥95%, salt PFE≥95%. In this embodiment, the melt-blown cloth is preferably provided with two layers, although in other embodiments, only one melt-blown cloth may be provided, as desired.

The inner functional cloth layer 18 may be woven from antibacterial yarns and deodorizing spandex yarns in weft knitting or warp knitting. Among them, the antibacterial yarn may preferably be provided as a polyester yarn with a zinc ion antibacterial agent. Compared with the traditional silver ion antibacterial agent, the zinc antibacterial agent has the characteristics of no toxicity, securing safety to human bodies and no pollution to the environment. The spandex yarn can utilize chemical bonds to attract odoriferous substances (such as acetic acid, ammonia, isovaleric acid, nonenal and the like) to reduce peculiar smell and further improve the deodorization effect.

After the antibacterial yarn and the spandex yarn are mixed and woven, the elasticity is good, such that the inner functional cloth layer 18 has a comfortable and soft hand feeling, and wrinkles are avoided, and the original contour of the mask is kept all the time.

As a further improvement of this embodiment, a quick-drying aid may be added to the inner functional cloth layer 18, which may preferably be provided as a moisture-absorbing and perspiration-releasing finishing agent that accelerates the rate of moisture absorption and perspiration release and provides a quick-drying effect to the mask.

Preferably, a fluorescent brightener may also be added to the inner functional cloth layer 18.

In addition, fragrances can be added to the inner functional cloth layer 18, so that the wearing experience of a user can be improved, and a peculiar smell can be covered.

As shown in 1, the strap 2 is connected to the mask body 1, wherein the strap may be provided as an elastic strap, and the connection may be a hot-melt or stitching means connection.

As shown in FIG. 1, a nose bridge metal strip 3 which is located at the upper end of the surface of the water repellent outer cloth layer 11 and can be bent can also be connected to the outside of the mask body 1.

In summary, the mask disclosed by the invention has the functions of antibiosis, deodorization and quick-drying, is high in comfort level, good in fit with the face, soft in hand feeling and high in filtering rate, and meets the requirements of national and international standards for filtering rate and breathing resistance.

The above-described embodiments are preferred embodiments of the present invention, but the embodiments of the present invention are not limited to the above-described embodiments, and any other changes, modifications, substitutions, combinations, simplifications, which do not depart from the spirit and principles of the present invention are intended to be equivalent within the scope of the present invention.

What is claimed is:

1. An antibacterial deodorant quick-drying mask, comprising a mask body and a strap connected to the mask body, wherein the mask body comprises a water repellent outer cloth layer, a first upright cotton layer, a first needle-punched cotton layer, a melt-blown cloth layer, a second needle-punched cotton layer, a second upright cotton layer and an inner functional cloth layer, wherein the water repellent outer cloth layer, the first upright cotton layer, the first needle-punched cotton layer, the melt-blown cloth layer, the second needle-punched cotton layer, the second upright cotton layer and the inner functional cloth layer are sequentially laminated and connected from outside to inside, the inner functional cloth layer is woven by antibacterial yarns and spandex yarns, and a quick-drying aid is added into the inner functional cloth layer.

2. The antibacterial deodorant quick-drying mask according to claim 1, wherein the antibacterial yarn is a polyester yarn with a zinc ion antibacterial agent.

3. The antibacterial deodorant quick-drying mask according to claim 1, wherein the quick-drying aid is a moisture-absorbing and perspiration-releasing finishing agent.

4. The antibacterial deodorant quick-drying mask according to claim 1, wherein a fluorescent brightener is also added in the inner functional cloth layer.

5. The antibacterial deodorant quick-drying mask according to claim 1, wherein a fragrance is also added into the inner functional cloth layer.

6. The antibacterial deodorant quick-drying mask according to claim 1, wherein the weaving mode of the antibacterial yarn and the spandex yarn is weft knitting or warp knitting.

7. The antibacterial deodorant quick-drying mask according to claim 1, wherein the gram weight of the first upright cotton layer, the first needle-punched cotton layer, the second needle-punched cotton layer, and the second upright cotton layer is 80-120 g/m².

8. The antibacterial deodorant quick-drying mask according to claim 1, wherein the melt-blown cloth layer is provided with two layers.

9. The antibacterial deodorant quick-drying mask according to claim 1, wherein the filtering rate of the melt-blown cloth layer is as follows: oil PFE≥95%, salt PFE≥95%.

10. The antibacterial deodorant quick-drying mask according to claim 1, wherein the water repellent outer cloth layer is made of water repellent polyester cloth, nylon cloth or non-woven cloth; and a nose bridge metal strip which is located at an upper end part of the surface of the water repellent outer cloth layer and can be bent is connected to the outside of the mask body.
